(19) United States
(12) Patent Application Publication
(10) Pub. No.: US 2007/0056182 A1
(43) Pub. Date: Mar. 15, 2007

(54) Tape measure with temporary braking mechanism

(76) Inventors: Anthony Di Bitonto, Brooklyn, NY (US); Kevin Lozeau, Ridge, NY (US); Conor McNamara, Brooklyn, NY (US)

Correspondence Address: SEYFARTH SHAW LLP, 131 S. DEARBORN ST., SUITE2400, CHICAGO, IL, 60603-5803, US

(21) Appl. No.: 11/227,753

(22) Filed: Sep. 15, 2005

(51) Int. Cl. G01B 3/10

(52) U.S. Cl. 33/767

(57) ABSTRACT

A tape measure is disclosed which includes a housing defining a chamber and having a peripheral wall with an aperture or opening, and an elongated coiled measuring tape blade within the housing chamber. The coiled tape blade typically includes an end with a hook thereon extending outwardly through the aperture and is capable of automatic retraction into the housing. A positive locking mechanism mounted on the peripheral wall for locking the tape blade at a selected position while the tape blade is in an extended position outside the housing, and a temporary braking mechanism mounted on the peripheral wall for controlling the rate of retraction of the extended tape blade into the housing are also disclosed. The temporary braking mechanism is preferably located opposite the positive locking mechanism with the tape blade extending therebetween, whereby, when external manual pressure is applied to the temporary brake mechanism, the tape blade is forced against the positive locking mechanism, reducing the retraction rate of the tape blade during automatic retraction into the housing.

### TECHNICAL FIELD

The present invention relates to coilable tape measures, and more particularly to a coilable tape measure allowing user control of the rate of retraction of a tape blade into the housing.

### BACKGROUND

Coilable tape measures are widely employed to facilitate taking measurements and to provide for the return of an extended tape blade into a housing for storage. The tape blade is generally constructed of metal, and a hook is secured to its outer surface end, which aids in the use of the tape blade by engaging an edge of a surface to be measured. Typically, the tape blade is spring-loaded and biased toward a retracted position within the housing. When the tape blade is fully retracted within the housing, the hook remains outside the housing so as to provide a point of engagement of the tape blade for the user.

A positive locking mechanism is typically provided so that the tape blade can be locked in a desired extended position for convenience in making measurements. The locking mechanism usually operates on the tape blade within the housing with a push-button actuator located on a surface of the housing so that it can be easily manipulated by the user's thumb. The lock is actuated when the tape blade is extended and then released when the user desires the tape blade to be automatically retracted and coiled within the housing.

Due to the spring used to retract and coil the extended tape blade into the housing, the tape blade often uncontrollably flexes or whips as it is being retracted, causing fatigue at the inner end of the tape blade and potentially damaging the measured surface.

Additionally, the unencumbered rate of retraction of the tape blade into the housing, when abruptly stopped by the abutment of the hook against the housing, results in shock loading about the fasteners connecting the hook to the tape blade that produces fatigue or shear. As a result, it is quite common for a tape blade to fracture or shear around the hook, which consequently causes the tape blade to be retracted and coiled completely into the housing, thereby preventing further use of the measuring tape.

Various measuring tape devices of the prior art have attempted to address the aforementioned problems through employing complicated means to control the rate of retraction of an extended tape blade into a tape measure housing. For example, U.S. Pat. No. 6,115,933 describes a decelerating lever, including a biasing V-shaped spring, having small projections extending therefrom. When the lever is depressed the projections contact the tape blade and force it into additional contact with an anvil to control the retraction rate. The decelerating lever, however, extends beyond the outer housing surface. Further, the lever relies on biasing from a separate additional component, the V-shaped spring, within the housing. These features may hinder use of the tape measure for some operations, and add complexity where simplicity is sought.

Thus, there is a need for a tape measure which controls the rate of retraction of an extended tape blade into a tape measure housing without providing complexity and without hindering operation of the tape measure. The present device addresses these and other problems of prior tape measure devices.

### SUMMARY

There is disclosed herein an improved tape measure which includes features for controlling the rate of retraction of an extended tape blade into a tape measure housing.

It is an object of the invention to provide a tape measure which controls the rate of retraction of an extended tape blade into a tape measure housing by contacting the curvilinear surface of the tape blade.

Another object of the invention is to provide a temporary brake mechanism that allows for the retraction of an extended tape blade to be temporarily halted while being retracted into the housing through the aperture by placing the tape blade in simultaneous contact with a temporary braking mechanism and a positive locking mechanism.

An illustrative embodiment of the present invention relates to a tape measure including a housing having peripheral walls defining a chamber, at least one peripheral wall having an aperture, an elongated coilable measuring tape blade within the housing chamber and extending outwardly through the aperture at an end having a hook thereon, wherein the tape blade is capable of being retracted automatically into the housing, a positive locking mechanism mounted on said peripheral wall for locking the tape blade at a selected position while the tape blade is in an extended position outside the housing, and a temporary braking mechanism mounted on the peripheral wall for controlling the rate of retraction of the extended tape blade into the housing, the temporary braking mechanism being located opposite the positive locking mechanism with the tape blade extending therebetween, whereby, when external manual pressure is applied to the temporary brake mechanism, the tape blade is forced against the positive locking mechanism, reducing the retraction rate of the tape blade during automatic retraction into the housing.

Another illustrative embodiment of the invention relates to a method for controlling a retraction rate of a tape blade during automatic retraction into a housing including the steps of applying pressure to a temporary braking mechanism mounted on a peripheral wall of a tape measure housing containing the tape blade, contacting the temporary braking mechanism to a lower surface of the tape blade, and optionally forcing an upper surface of the tape blade opposite the lower surface into contact with a positive locking mechanism.

A more detailed explanation of the invention is provided in the following description and claims and is illustrated in the accompanying drawings.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a perspective view of an embodiment of the present tape measure;

FIG. 2 is a perspective view of the tape measure shown in FIG. 1 taken from the opposite side;

FIG. 3 is an exploded view of an embodiment of the present tape measure;

FIG. 4 is a perspective view with one side of the tape measure housing removed to show various axes of rotation;

FIG. 5 is a side view of the tape measure illustrated in FIG. 4 with the positive locking mechanism in an unlocked position;

FIG. 6 is a side view of the tape measure illustrated in FIG. 4 with the positive locking mechanism in a locked position; and

FIG. 7 is a detailed view of the area circled in FIG. 5 showing the temporary braking mechanism engaged with the tape blade.

### DETAILED DESCRIPTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

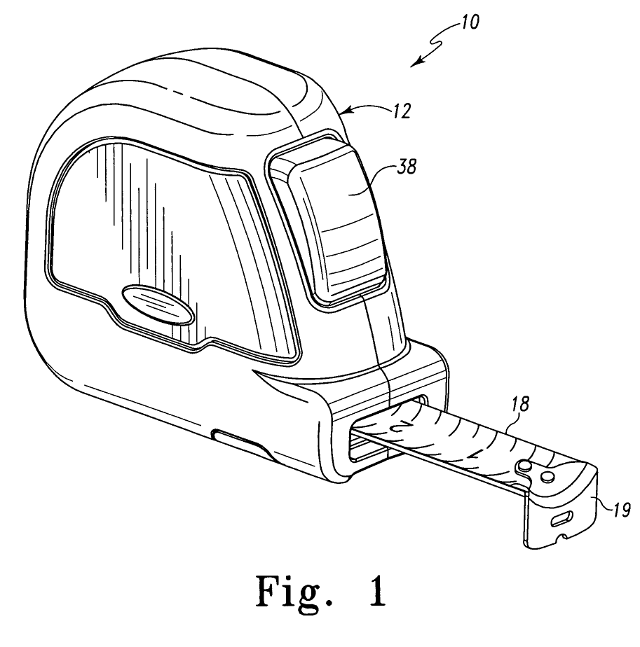

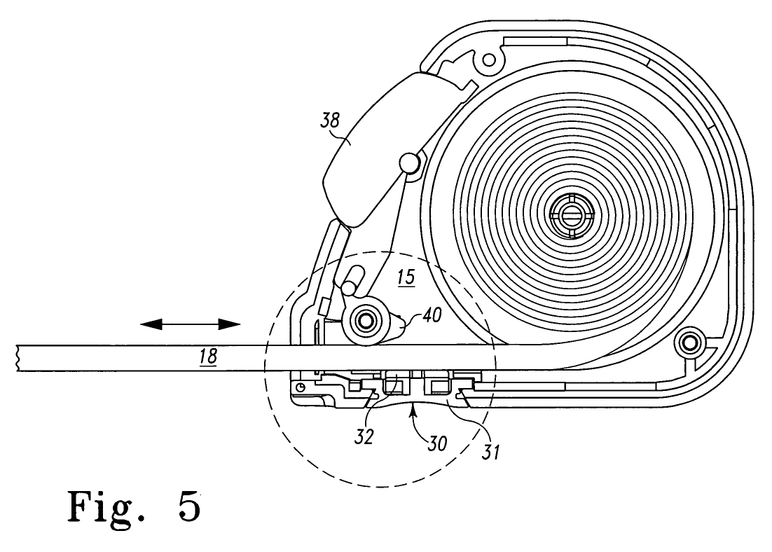

Referring generally to FIGS. 1-7, there is depicted a tape measure 10 which includes a housing 12. The housing 12 is preferably a split-type housing including portions 13a and 13b and having an aperture 14 on a peripheral side 16—“peripheral” meaning any of the exterior surfaces of the housing 12 of tape measure 10—through which a tape blade 18 can be extended out of and retracted into housing chamber 15. A hook 19 is provided at an end of tape blade 18 to engage the end of a surface to be measured, as well as to prevent the tape blade 18 from completely retracting within the housing 12 around tape spool 20.

The tape spool 20 incorporates a spring means 29 whereby the tape blade 18 is spring loaded and biased toward a retracted position within the housing chamber 15. The spool 20 is secured onto a cylindrical boss 22 molded integrally with and projecting interiorly from housing portion 13a. This type of automatically retractable, spring-loaded coilable tape blade is well known in the industry.

As stated above, the housing 12 is formed as a split-type housing, which is also known in the measuring tape art. The utilization of the split-type housing 12, including portions 13a and 13b, facilitates assembly of the device. The portions 13a and 13b of the housing 12 are secured together by fasteners, not shown, as is well known in the art. The fasteners may project through either housing portion 13a or 13b and into internal bosses 23 molded in the remaining housing portion 13a or 13b. The housing 12 can be made of plastic, metal or any other suitable material. Preferably, each of the housing portions 13a and 13b is a molded plastic material, whereby various bosses, flanges, side rails and positioning means for various components and the like can be molded integrally on the interior of the housing portions 13a and 13b without requiring numerous separate parts.

The housing 12 is dimensioned and configured to be held by the user around a lower area 28, with the user's thumb overlying a portion of a peripheral side 16. The lower area 28 of the housing 12 includes an opening 26 for accommodating a temporary braking mechanism 30. In a preferred embodiment, the temporary braking mechanism 30 includes an outer diaphragm 31 mounted within peripheral wall 16 and an internal brake element 32 contacting diaphragm 21, but located within chamber 15. It is anticipated that the diaphragm 31 and brake element 32 may be either separate components or a single piece. The diaphragm 31 is designed to allow inward flexing to direct the brake element 32 into contact with the tape blade 18, as discussed in detail below. The temporary braking mechanism 30 is broadly considered to be within the peripheral wall 16 of the housing 12 so long as at least an actuating component, in the present case, the diaphragm 31, is accessible along a peripheral wall 16. The myriad of alternate configurations which may be possible to adequately perform the temporary braking function, in light of the present disclosure, are too numerous to be discussed in this application. However, any combination of components, other than the positive locking mechanism, which act to suitably engage tape blade 18 and thereby decrease the rate of retraction of the tape into the housing 12 is considered to fall within the scope of the appended claims.

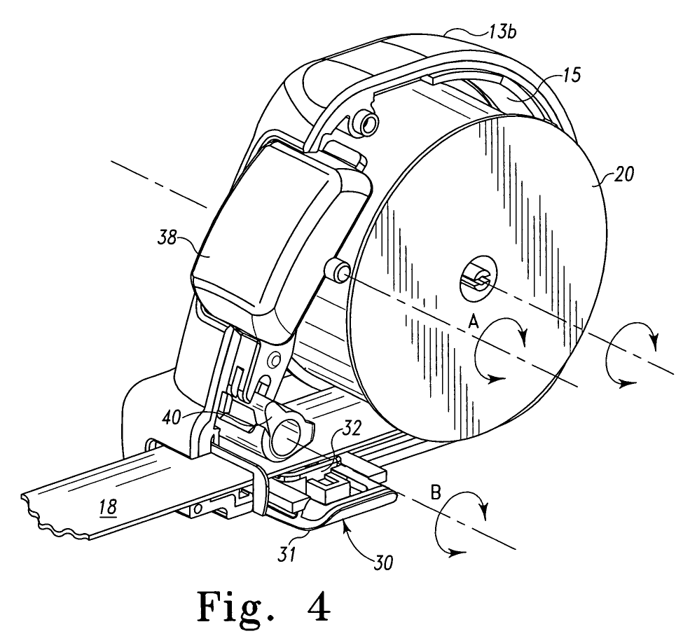

The housing 12 additionally includes an opening 34 for receiving a positive locking mechanism 36. The positive locking mechanism 36 includes an actuator 38 that is moveably engaged to both housing portions 13a and 13b and a lever arm 40 moveably engaged to the actuator 38. Preferably, the actuator 38 and lever arm 40 operate as an elbow joint for applying a positive lock on the tape blade 18. The positive locking mechanism 36 is selectively operable for applying a positive lock on tape blade 18 to prevent the retraction of the tape blade. The actuator 38 is depressed inward at the bottom portion to rotate about the axis A, as shown in FIG. 4, to apply a positive lock on the tape blade 18. Depressing the actuator 38 along the bottom portion rotates lever arm 40 about axis B, also shown in FIG. 4, to directly engage tape blade 18 and prevent its retraction. Likewise, the actuator 38 is depressed inward at the top portion to rotate in the opposite direction about axis A and remove the positive lock on the tape blade 18 by rotating lever arm 40 about axis B, which disengages tape blade 18 to permit its retraction. Additionally, an insert 42 may be provided to protect the housing portions 13a and 13b around the aperture from scratching by the sides of the tape blade 18.

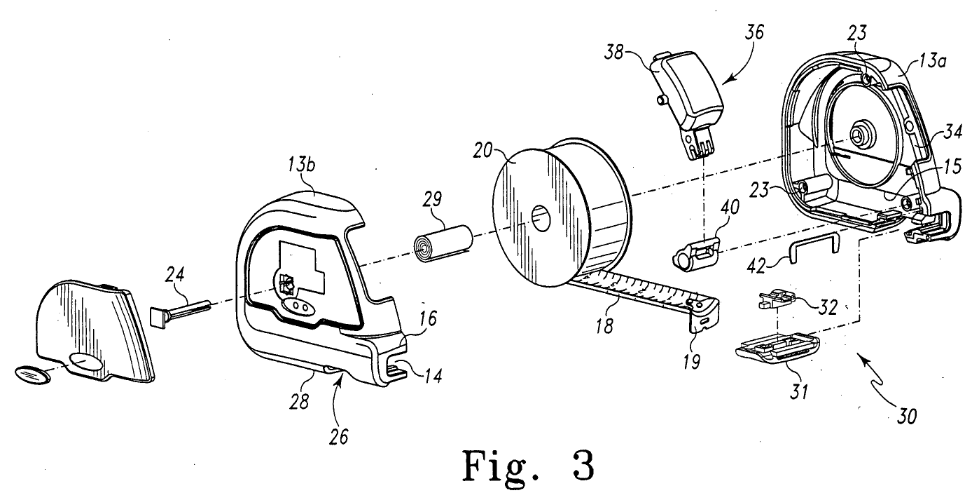

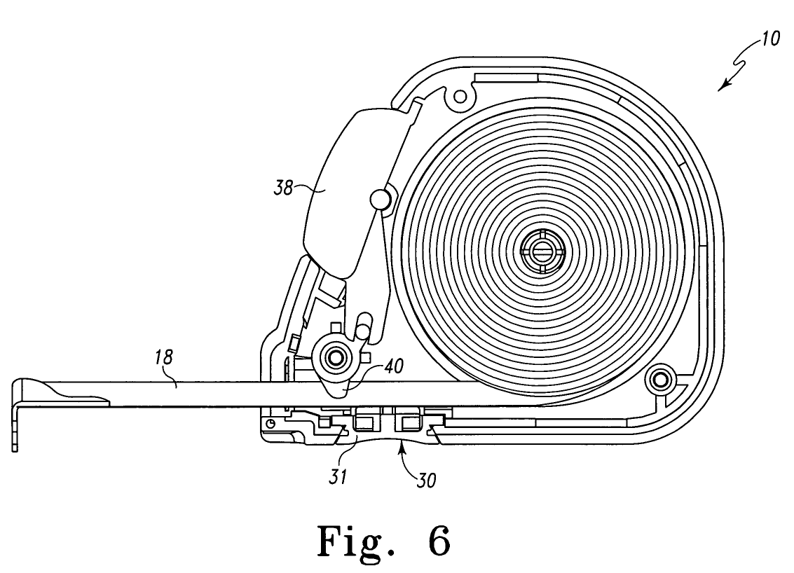

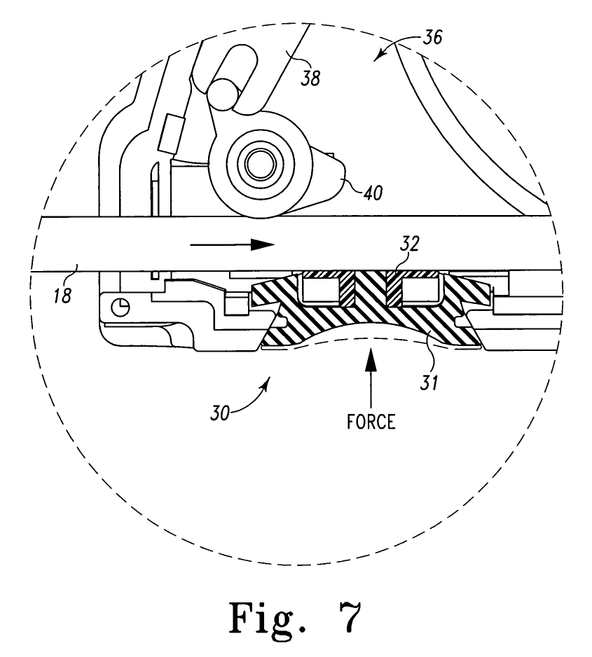

Referring now to FIGS. 3-7, in operation, a user pulls on the hook 19 and extends the tape blade 18 so as to mark a measurement. When the appropriate length of tape blade 18 has been extended, the user will depress the actuator 38, and the tape blade 18 will be positively locked in a desired position (FIG. 6). This will prevent the tape blade 18 from automatically retracting into the chamber 15. After the taking of the measurement is completed, the actuator 38 is depressed and the tape blade 18 retracts under spring bias into the chamber 15. As the tape blade 18 retracts into housing 12, rotational forces drive the tape blade 18 toward lower area 28. In order to reduce or control the rate of retraction of the tape blade 18, the temporary braking mechanism 30 is manually pressed into engagement with the tape blade 18. By varying the amount of force applied to the diaphragm 31 of the temporary braking mechanism 30, the rate of retraction of tape blade 18 can be controlled. For example, as illustrated in FIG. 7, the temporary braking mechanism 30 can be pressed with an amount of force sufficient to only permit contact between the tape blade 18 and brake element 32, thereby reducing the rate of retraction as a result of the frictional forces between the element 32 and the retracting tape blade 18. Preferably, the brake element 32 is curvilinear in shape so as to contact the tape blade 18 along its respective curvilinear surface. Additionally, the brake element 32 may be integrally formed as a portion of diaphragm 31. Accordingly, the brake element 32 provides a curvilinear surface capable of contacting a substantial portion of the corresponding curvilinear surface of the tape blade 18. Thus, as a result of the aforementioned rotational forces on the tape blade 18 during retraction, the temporary braking mechanism 30 is capable of reducing the rate of retraction of the tape blade 18 without the need of another structure, such as the anvil of the prior art, to press on the tape blade 18 opposite of the temporary braking mechanism 30.

Alternatively, the temporary braking mechanism 30 can be pressed with a greater amount of force sufficient to permit contact between the curvilinear brake element 32 and the curvilinear lower surface of tape blade 18, as well as the lever arm 40 and the upper surface (opposite the lower surface) of tape blade 18. As a result, the retraction of tape blade 18 can be halted temporarily.

The temporary braking mechanism 30 permits sufficient control of the rate of retraction and, as a result, can reduce the shock of the impact of retraction upon the tape blade 18 so that damage to the hook 19 and associated end is prevented, thereby extending the useful life of the tape measure 10.

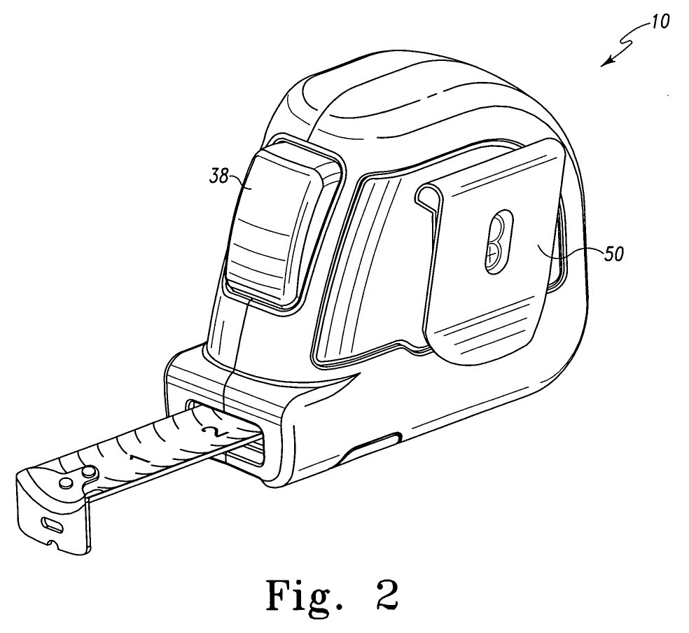

Referring specifically to FIG. 3, the housing 12 may be encased in an over-molded elastomeric material, such as rubber. Such an over-molded elastomeric material provides the user with a high grip surface, so that the tape measure 10 can be easily handled. Further, as illustrated in FIG. 2, a belt clip 50 can be mounted to the housing 12 to permit the user to releasably secure the tape measure 12 to belt or other structure (not shown). Preferably, the belt clip 50 is biased to a closed position, thereby resisting inadvertent attempts to disengage the tape measure 10 from a structure.

A tape measure as detailed herein may be utilized in various forms. One such tape measure may be useful for reducing the rate of retraction of the tape blade without stopping retraction without the need of another structure to press on the tape blade opposite of the temporary braking mechanism. Another such tape measure may incorporate a positive locking mechanism adapted to cooperate with temporary braking mechanism, so as to further reduce the rate of retraction. From the foregoing, it can be seen that there has been provided an improved tape measure which greatly facilitates the control of the rate of retraction of the tape blade.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tape measure comprising:
a housing providing a chamber and having a peripheral wall with an aperture;
an elongated coilable measuring tape blade within the housing chamber and extending outwardly through the aperture at an end having a hook thereon, wherein the tape blade is capable of being retracted automatically into the housing;
a positive locking mechanism extending through the peripheral wall for locking the tape blade at a selected position while the tape blade is in an extended position outside the housing; and
a temporary braking mechanism mounted on the peripheral wall for controlling the rate of retraction of the extended tape blade into the housing, the temporary braking mechanism being located opposite the positive locking mechanism with the tape blade extending therebetween, whereby, when external manual pressure is applied to the temporary braking mechanism, a brake element is forced against the tape blade, reducing the retraction rate of the tape blade during automatic retraction into the housing.

2. The tape measure according to claim 1, wherein the brake element is curvilinear for contacting a curvilinear portion of a second surface of the tape blade opposite a first surface.

3. The tape measure according to claim 2, wherein the brake element is integrally formed as a portion of the temporary braking mechanism.

4. A method for controlling a retraction rate of a tape blade during automatic retraction into a housing, the method comprising the steps of:
applying pressure to a temporary braking mechanism mounted on a peripheral wall of a tape measure housing containing the tape blade; and
contacting a brake element of the temporary braking mechanism to a lower surface of the tape blade.

5. The method according to claim 4, further comprising the step of forcing an upper surface of the tape blade opposite the lower surface into contact with a positive locking mechanism.

6. The method according to claim 4, wherein the brake element is curvilinear for contacting a curvilinear portion of the lower surface.

7. A tape measure comprising:
a housing providing a chamber and having a peripheral wall with an aperture;
an elongated coilable measuring tape blade within the housing chamber and extending outwardly through the aperture at an end having a hook thereon, wherein the tape blade is capable of being retracted automatically into the housing;
a positive locking mechanism mounted on said peripheral wall for locking the tape blade at a selected position while the tape blade is in an extended position outside the housing; and
a temporary braking mechanism mounted on the peripheral wall for controlling the rate of retraction of the extended tape blade into the housing, the temporary braking mechanism being located opposite the positive locking mechanism with the tape blade extending therebetween, whereby, when external manual pressure is applied to the temporary brake mechanism, the tape blade is forced against the positive locking mechanism, reducing the retraction rate of the tape blade during automatic retraction into the housing.

8. The tape measure according to claim 7, wherein the temporary braking mechanism includes a curvilinear brake element for contacting a second surface of the tape blade opposite the first surface.

9. The tape measure according to claim 8, wherein the curvilinear brake element contacts a corresponding curvilinear portion of the second surface.

10. The tape measure according to claim 9, wherein the brake element is integrally formed as a portion of the temporary braking mechanism.
